(19) United States
(12) Patent Application Publication
(10) Pub. No.: US 2020/0065008 A1
(43) Pub. Date: Feb. 27, 2020

(54) METHOD OF MONITORING MEMORY USAGE AND SUBSTRATE PROCESSING APPARATUS

(71) Applicant: SEMES Co. Ltd., Cheonan-si (KR)

(72) Inventor: Sangman YIM, Pyeongtaek-si (KR)

(73) Assignee: SEMES Co. Ltd., Cheonan-si (KR)

(21) Appl. No.: 16/535,125

(22) Filed: Aug. 8, 2019

(30) Foreign Application Priority Data
Aug. 23, 2018 (KR) 10-2018-0098541

(51) Int. Cl. G06F 3/06

(52) U.S. Cl. CPC G06F 3/0617; G06F 3/0673; G06F 3/0653

(57) ABSTRACT

The present invention relates to a method of monitoring a memory usage and a substrate processing apparatus. The method of monitoring a memory usage of the present invention comprises: a memory usage collecting step of collecting a memory usage according to a predetermined collection period; a memory leak determining step of determining a memory leak based on the collected memory usage; and an alarm processing step of generating an equipment alarm based on the determining result of the memory leak, wherein the memory leak determining step includes a first memory leak determining step of determining the memory leak by comparing the memory usage with a predetermined threshold value and a second memory leak memory step of determining the memory leak based on a change trend of the memory usage when the memory usage does not exceed the predetermined threshold value.

### CROSS-REFERENCE TO RELATED APPLICATION

This application claims the benefit under 35 U.S.C. 119(a) of Korean Patent Application No. 10-2018-0098541 filed on Aug. 23, 2018, in the Korean Intellectual Property Office, the entire disclosure of which is incorporated herein by reference for all purposes.

### TECHNICAL FIELD

The present invention relates to a method of monitoring a memory usage and a substrate processing apparatus, and more particularly, to prevent an equipment driving stop due to the memory usage exceeding an allowable value.

### BACKGROUND ART

A substrate processing apparatus driven in the factory continuously performs a substrate processing process. Since the substrate processing apparatus continuously performs the substrate processing process, internal components of the substrate processing apparatus may be deteriorated. When the internal components are deteriorated and thus the driving of the substrate processing apparatus is stopped, an operator determines a driving stop cause of the substrate processing apparatus to replace the deteriorated components or perform other operations, thereby removing the driving stop cause of the substrate processing apparatus. That is, when a problem relating to the hardware occurs in the substrate processing apparatus, the operator may determine the cause and remove the cause.

Unlike this, the main computer provided in the substrate processing apparatus may be stopped due to an unknown reason or a driving program of the substrate processing apparatus may be terminated due to an unknown reason. When the main computer is stopped or the driving program of the substrate processing apparatus is terminated, the operator may not find and remove the cause of the driving stop in the main computer. Even if the operator is a programmer, it takes a long time for the operator to find and analyze the cause stop cause of the main computer or the termination cause of the driving program of the substrate processing apparatus. Since a substrate processing apparatus with an emphasis on productivity can not be left for a long time, an operator has no choice but to generate a log on the main computer and reset the equipment together with the main computer. In addition, substrates that are being processed in the equipment may be discarded. That is, when a problem related to software occurs in the substrate processing apparatus, the operator may not determine the cause and may not eliminate the cause.

On the other hand, one of the causes of the software-related problem is a memory usage that exceeds an allowable value. The substrate processing apparatus driving program for driving the substrate processing apparatus is executed in the main computer provided in the substrate processing apparatus. It takes much time and many efforts for the operator to monitor the memory usage of the main computer in order to prevent the driving stop of the substrate processing apparatus due to the memory usage exceeding the allowable value. This is because there is not only one substrate processing apparatus but a plurality of substrate processing apparatuses in the factory.

### DISCLOSURE

### Technical Problem

An object of the present invention is to provide an effective method of monitoring a memory usage and a substrate processing apparatus for preventing an equipment driving stop due to a memory usage exceeding an allowable value.

### Technical Solution

In order to achieve the objects, the present invention provides a method of monitoring a memory usage comprising: a memory usage collecting step of collecting a memory usage according to a predetermined collection period; a memory leak determining step of determining a memory leak based on the collected memory usage; and an alarm processing step of generating an equipment alarm based on the determining result of the memory leak, in which the memory leak determining step includes a memory leak determining step of determining the memory leak by comparing the memory usage with a predetermined threshold value and a memory leak memory step of determining the memory leak based on a change trend of the memory usage when the memory usage does not exceed the predetermined threshold value.

The determining of the memory leak by comparing the memory usage with the predetermined threshold value may be determining the memory leak if the memory usage exceeds the predetermined threshold value.

The memory usage may be at least one of a memory usage for the entire application and a memory usage for each application.

The method may further include a step of accumulating and storing the memory usage in a memory, in which the determining of the memory leak based on a change trend of the memory usage includes determining the number of times of updating the maximum value of the memory usage during a predetermined period in the memory usage accumulated and stored for each collection period and determining a memory leak when the number of times of updating the maximum value of the memory usage exceeds the threshold number of updating times during the predetermined period.

The method may further include a step of accumulating and storing the memory usage collected for each collection period in a memory, in which the determining of the memory leak based on a change trend of the memory usage includes determining whether or not to update the maximum value of the memory usage during a predetermined period in the memory usage accumulated and stored for each collection period and determining a memory leak when the updating of the maximum value of the memory usage continuously occurs during the predetermined period.

The memory usage may be at least one of a memory usage for the entire application and a memory usage for each application.

Further, the present invention provides a substrate processing apparatus comprising: a memory usage collecting unit configured to collect a memory usage according to a predetermined collection period; a memory leak determining unit configured to determine a memory leak based on the memory usage; and an equipment alarm processing unit configured to generate an equipment alarm based on the determining result of the memory leak, in which the memory leak determining unit determines the memory leak by comparing the memory usage with a predetermined threshold value and determines the memory leak based on a change trend of the memory usage when the memory usage does not exceed the predetermined threshold value.

The memory leak determining unit may determine the memory leak if the memory usage exceeds the predetermined threshold value when determining the memory leak by comparing the memory usage with the predetermined threshold value.

The memory usage may be at least one of a memory usage for the entire application and a memory usage for each application.

The substrate processing apparatus may further include a memory usage storing unit of accumulating and storing the memory usage, in which the memory leak determining unit determines the number of times of updating the maximum value of the memory usage during a predetermined period in the memory usage accumulated and stored for each collection period when determining the memory leak based on a change trend of the memory usage and determines a memory leak when the number of times of updating the maximum value of the memory usage exceeds the threshold number of updating times during the predetermined period.

The substrate processing apparatus may further include a memory usage storing unit of accumulating and storing the memory usage, in which the memory leak determining unit determines whether or not to update the maximum value of the memory usage during a predetermined period in the memory usage stored for each collection period and determines a memory leak when the updating of the maximum value of the memory usage continuously occurs during the predetermined period.

The memory usage may be at least one of a memory usage for the entire application and a memory usage for each application.

### Advantageous Effects

According to the present invention, it is possible to increase productivity of the substrate processing apparatus by preventing the driving stop of the substrate processing apparatus in advance by determining the memory leak.

According to the present invention, when it is determined that there is a memory leak, the user may recognize in advance the existence of the memory leak through an alarm.

According to the present invention, since it is not necessary for the user to directly monitor the memory leak, manpower, time, and cost may be saved in monitoring the memory usage.

According to the present invention, it is possible to determine which one of the applications has used the memory beyond the allowable value by determining the memory leak with respect to the memory usage for the entire application and the memory usage for each application.

### DESCRIPTION OF DRAWINGS

FIG. 1 is a flowchart illustrating a method of monitoring a memory usage according to an embodiment of the present invention.

FIG. 2 is a diagram illustrating an example for a memory usage collected and stored according to a predetermined collection period according to the method of monitoring the memory usage according to the embodiment of the present invention.

FIG. 3 is a schematic configuration diagram of a substrate processing apparatus according to an embodiment of the present invention.

### MODES OF THE INVENTION

Hereinafter, the present invention will be described in detail with reference to the accompanying drawings.

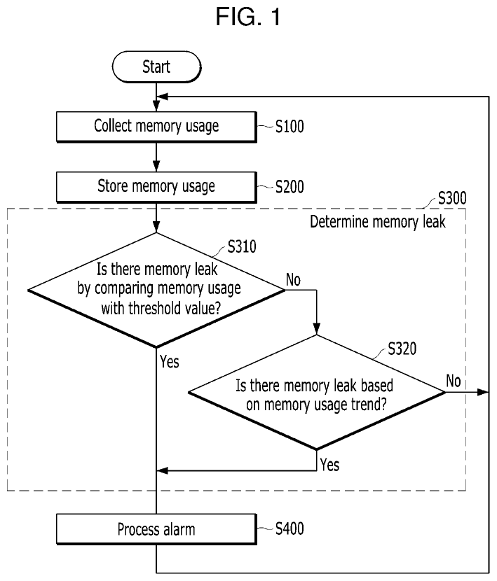

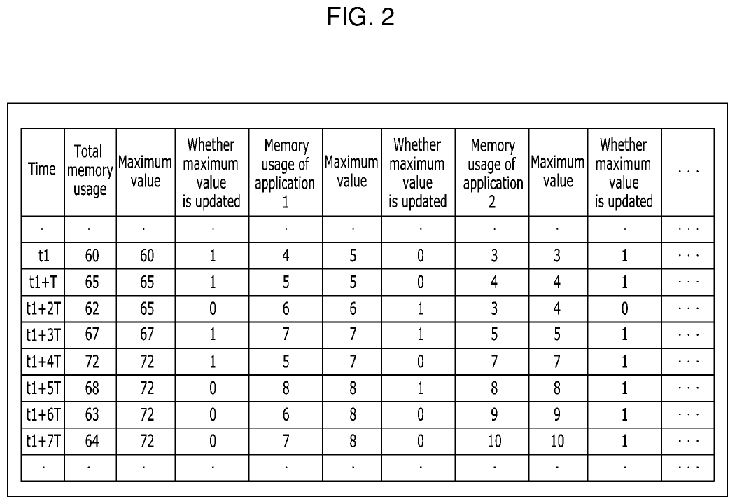

FIG. 1 is a flowchart illustrating a method of monitoring a memory usage according to an embodiment of the present invention and FIG. 2 is a diagram illustrating an example for a memory usage collected and stored according to a predetermined collection period according to the method of monitoring the memory usage according to the embodiment of the present invention.

Referring to FIG. 1, a method for monitoring a memory usage according to an embodiment of the present invention includes a memory usage collecting step (S100), a memory usage storing step (S200), a memory leak determining step (S300), and an alarm processing step (S400).

In the memory usage collecting step (S100), the memory usage is collected according to a predetermined collection period. The memory usage to be collected becomes a memory leak determination target in the subsequent memory leak determining step (S300). The memory may include at least one of a virtual memory and a physical memory.

The memory usage may be a memory usage for the entire application driven in the substrate processing apparatus. Alternatively, the memory usage may be a memory usage for each of applications or a memory usage for a specific application. The memory usage may be both a memory usage for all of the application driven by the substrate processing apparatus and a memory usage for each application.

A method of acquiring the memory usage for at least one application may use a known method. For example, in a NET framework environment, the memory usage of all of the applications or each application may be obtained using the Performance Counter class. In a C/C++ environment, the memory usage of all of the applications or each application may be obtained by using WIN32 API, a performance data handler (PDH), winmm.lib, and psapi.lib. In addition, the memory usage of all of the applications or each application may be obtained by other known methods.

A collection period T of the memory usage is set by default or by a user and may be updated by the user. Meanwhile, although the operation of collecting the memory usage is performed according to the collection period, when the memory usage is not collected or the memory usage is not collected during a plurality of collection periods, although not illustrated in FIG. 1, the alarm processing step (S400) may be performed.

If equipment is reset or a main computer driving the equipment is reset, the memory usage of all of the applications or each application may not be collected until the equipment or the main computer is booted. If the equipment is reset or the main computer driving the equipment is reset, the memory usage may be collected, but may not be used for the memory leak determination.

In the memory usage storing step (S200), the memory usage collected according to the collection period T is stored. The memory usage is stored for each collection period to be data for determining the memory leak in the memory leak determining step (S300).

When the memory usage for the entire application is collected, the memory usage for the entire application may be stored in memory. The memory usage to be stored is the collected memory usage, which may be a memory usage for the entire application driven on the substrate processing apparatus. Alternatively, the memory usage to be stored may be a memory usage for each of applications or a memory usage for a specific application. The memory usage to be stored may be both a memory usage for all the application and a memory usage for each application driven by the substrate processing apparatus.

Referring to FIG. 2, the memory usage for all of the collected applications or each application is stored in a storage having a storage function. For example, memory usages for the entire application are 60%, 65%, 62%, 67%, 72%, 68%, 63%, and 64% when t1, t1+T, t+2T, t1+3T, t1+4T, t1+5T, t1+6T, and t1+7T, respectively.

On the other hand, if the measured or stored current time is t1+5T, t1 may be seen as a previous time by 5T from the current measured or stored time. Assuming that the most recently measured time is t1+5T, the memory usage for the entire application is 60%, 62%, 67%, 72% and 68% for t1, t1+T, t+2T, t1+3T, t1+4T, and t1+5T, respectively.

Further, the maximum value of the memory usage for the entire application or each of the applications may be selectively determined and stored for each collection period. For example, maximum values of the memory usages for the entire application are 60%, 65%, 65%, 67%, 72%, 72%, 72%, and 72% when the collection time or the storage time is t1, t1+T, t+2T, t1+3T, t1+4T, t1+5T, t1+6T, and t1+7T, respectively.

Further, when the maximum value of the memory usage for the entire application or each application is determined and stored for each collection period, whether the maximum value of the memory usage for the entire application or each application is updated may be determined and stored for each collection period.

For example, it is assumed that when the maximum value of the memory usage of the application is updated, whether the maximum value is updated is stored as 1, and when the maximum value of the memory usage of the application is not updated, whether the maximum value is updated is stored as 0. When the collection time or storage time is t1, t1+T, t+2T, t1+3T, t1+4T, t1+5T, t1+6T, and t1+7T, the maximum value of the memory usage for the entire application illustrated in FIG. 2 is stored as 1, 1, 0, 1, 1, 0, 0, and 0, respectively.

Specifically, when the maximum value of the memory usage for the entire application recorded before the measurement time t1 is less than 60%, the maximum value of the memory usage for the entire application is updated to 60% when the measurement time is t1, and thus whether the maximum value is updated is stored as 1. When the measurement time is t1+T, the maximum value of the memory usage for the entire application is updated to 65% and thus whether the maximum value is updated is stored as 1. Further, since the maximum value of the memory usage is not updated when the measurement time for the entire application is t1+2T, whether the maximum value is updated is stored as 0. When the measurement time is t1+3T, the maximum value of the memory usage for the entire application is updated to 67% and thus whether the maximum value is updated is stored as 1. When the measurement time is t1+4T, the maximum value of the memory usage for the entire application is updated to 72% and thus whether the maximum value is updated is stored as 1. Further, when the measurement time is t1+5T, t1+6T, and t1+7T, the maximum value of the memory usage for the entire application is not updated, and thus whether the maximum value is updated may be stored as 0.

The maximum value of the memory usage and whether the maximum value is updated may be data when the memory leak is determined based a memory usage trend in the memory leak determining step (S300).

As described above, the memory usage, the storage of the maximum value of the memory usage, and whether the maximum value of the memory usage is updated may be performed for at least one of the entire application, each application, and a specific application in the memory usage storing step (S100). Unlike this, only the memory usage may be stored. The memory usage storing step may be performed for at least one of the entire application, each application, and a specific application.

In the memory leak determining step (S300), the memory leak is determined based on the memory usage. When it is determined that there is the memory leak, the alarm processing step (S400) is performed, and when there is no memory leak, the memory usage collecting step (S100) is performed.

The memory leak determining step (S300) includes a first memory leak determining step (S310) of determining the memory leak by comparing the memory usage with a predetermined threshold value and a second memory leak memory step (S320) of determining the memory leak based on a change trend of the memory usage when the memory usage does not exceed the predetermined threshold value.

In the first memory leak determining step (S310), when the memory usage for the entire application exceeds the predetermined threshold value for the entire application, it may be determined that there is the memory leak.

In the first memory leak determining step (S310), when one of the memory usages for each application exceeds the predetermined threshold value for each application, it may be determined that there is the memory leak.

In the first memory leak determining step (S310), when one of the memory usages for the entire application and each application exceeds the predetermined threshold value for each application, it may be determined that there is the memory leak.

In the first memory leak determining step (S310), when the memory usage for the specific application exceeds the predetermined threshold value, it may be determined that there is the memory leak.

In the first memory leak determining step (S310), when one of the memory usages for the entire application and each application exceeds the predetermined threshold value for the entire application or each application, it may be determined that there is the memory leak.

For example, it is assumed that the predetermined threshold value for the entire application is 70%. When the memory usage of the entire application exceeds 70% of the threshold value, it may be determined that there is a memory leak for the entire application.

The threshold value may be a predetermined threshold value for the entire application or a predetermined threshold value for each application. The predetermined threshold value for each application may be set differently for each application.

Referring to FIG. 2, when the measurement time or the storage time is between t1 and t1+3T, the memory usage for the entire application does not exceed the threshold value of 70%. However, at t1+4T, the memory usage for the entire application exceeds the threshold value of 70%. Therefore, at t1+4T, it is determined that there is a memory leak for the entire application, and the alarm processing step (S400) may be performed.

For example, when the threshold value for the memory usage set for the application 1 is 7%, if the collected memory usage for application 1 exceeds 7%, it is determined that there is a memory leak for the application and the alarm processing step (S400) may be performed. In the case of application 1, it is determined that there is a memory leak at t1+5T, and the alarm processing step (S400) may be performed.

Meanwhile, in the case where it is determined that there is a memory leak for the entire application and each application, if it is determined that there is a memory leak for any one of the entire application and each application, the alarm processing step (S400) may be performed. In this case, the memory usages for both the entire application and each application need to be collected and stored in the memory usage collecting step (S100) and the memory usage storing step (S200).

Meanwhile, if it is determined that there is a memory leak for the entire application or a specific application, the memory usage for the entire application or the specific application needs to be collected and stored in the memory usage collecting step (S100) and the memory usage storing step (S200).

The predetermined threshold value may be initially set, and may be set or updated by the user.

The threshold value for the memory usage for one application may be configured with at least one threshold value. For example, the threshold value set for the entire application may be configured to have a first threshold value of 65%, a second threshold value of 75%, and a third threshold value of 85%. If the memory usage of the entire application is increased to 50%, 60%, 70%, 80%, and 90%, alarm may be generated by varying alarm levels based on each threshold value.

The threshold value for the memory usage of the application may be set based on memory sizes including a virtual memory and a physical memory. That is, when the initial memory size of the application is X, the threshold value may be set to a multiple of X.

In addition, the threshold value for the memory usage of the application may be the threshold value for the memory usage updated in accordance with the alarm process in the alarm processing step (S400).

If it is determined that there is a memory leak for the entire application or each application in the first memory leak determining step (S310), during the process of monitoring the memory usage of the substrate processing apparatus, the equipment alarm processing step (S400) is performed, and otherwise, the second memory leak determining step (S320) is performed.

In the second memory leak determining step (S320), it is determined whether there is a memory leak based on the change trend in the memory usage. In the present invention, the process of determining the change trend in the memory usage based on the number of update times of the maximum value of the memory usage is determined, but the present invention is not limited thereto.

The second memory leak determining step (S320) is performed if it is determined that there is no memory leak for the entire application and each application in the first memory leak determining step (S310).

If whether the maximum value of the memory usage is updated is stored in the memory usage storing step (S200), it is determined whether there is the memory leak for the entire application or each application by using the update of the maximum value of the memory usage in the second memory leak determining step (S320).

Meanwhile, when whether the maximum value of the memory usage is updated is not stored in the memory usage storing step (S200), after the update of the maximum value of the memory usage is determined in the second memory leak determining step (S320), the memory leak is determined using the stored memory usage.

In the second memory leak determining step (S320), if the number of times of updating the maximum value of the memory usage during a predetermined period L1 exceeds the threshold number of updating times (N), it may be determined that there is a memory leak for the entire application or each application.

The second memory leak determining step (S320) will be described below with reference to an example illustrated in FIG. 2.

First, it is assumed that a predetermined threshold value of application 1 is 10% and it is determined that there is no memory leak in the first memory leak determining step (S310). When the collection time or the storage time is t1, t1+T, t+2T, t1+3T, t1+4T, t1+5T, t1+6T, and t1+7T in the memory usages of application 1 stored in the memory, a maximum value of the memory usage for application 1 is 5%, 5%, 6%, 7%, 7%, 8%, 8%, and 8%, respectively.

It is assumed that when the maximum value of the memory usage of the application is updated, whether the maximum value is updated is set to 1, and when the maximum value of the memory usage of the application is not updated, whether the maximum value is updated is set to 0. When it is assumed that the maximum value is not updated when the collection or measurement time is t1, if the collection time or the storage time is t1, t1+T, t+2T, t1+3T, t1+4T, t1+5T, t1+6T, and t1+7T in the maximum value of the memory usage of application 1, whether the maximum value of the memory usage is updated is set to 0, 0, 1, 1, 0, 1, 0, and 0, respectively.

If the predetermined period L1 is 4T and the threshold number of updating times N is 3, when the measurement time is t1+5T, the number of times of updating the maximum value of the memory usage is 3 during the predetermined periods t1+T to t1+5T, and thus it may be determined that there is a memory leak for application 1. At this time, when the current collection time or measurement time is t1+5T, it may be determined that when the collection time or storage time is t1+T, whether the maximum value is updated is excluded or included.

As another method, the second memory leak determining step may be performed. That is, when the maximum value of the memory usage is continuously updated during a predetermined period L2, it may be determined that there is a memory leak in the corresponding application.

The second memory leak determining step (S320) performed by another method will be described below with reference to an example illustrated in FIG. 2.

When the collection time or the storage time is t1, t1+T, t+2T, t1+3T, t1+4T, t1+5T, t1+6T, and t1+7T in the memory usages of application 2 stored in the memory, a maximum value of the memory usage for application 2 is 3%, 4%, 4%, 5%, 7%, 8%, 9%, and 10%, respectively.

It is assumed that when the maximum value of the memory usage of application 2 is updated, whether the maximum value is updated is set to 1, and when the maximum value of the memory usage of application 2 is not updated, whether the maximum value is updated is set to 0. When it is assumed that the maximum value is updated when the collection time or the storage time is t1, if the collection time or the storage time is t1, t1+T, t+2T, t1+3T, t1+4T, t1+5T, t1+6T, and t1+7T in the maximum value of the memory usage of application 2, whether the maximum value of the memory usage is updated is set to 1, 1, 0, 1, 1, 1, 1, and 1, respectively.

If the predetermined period L2 is 4T, when the collection time or the storage time is t1+6T, the maximum value of the memory usage is continuously updated during the predetermined periods t1+3T to t1+6T, and thus it may be determined that there is a memory leak.

Meanwhile, the threshold value may be applied even in the second memory leak determining step. The second memory leak determining step (S320) may be performed based on the memory usage trend only when the memory usage of the application is higher than the threshold value applied to the second memory leak determining step (S320). The threshold value used in the second memory leak determining step (S320) is a smaller threshold value than the threshold value used in the first memory leak determining step (S310).

Unlike this, a difference value for the memory usage during a predetermined period L3 may be used.

Meanwhile, the maximum value of the memory usage may be reset together when the substrate processing apparatus or the main computer driving the substrate processing apparatus is reset. The maximum value of the memory usage may also be reset by the user.

In the alarm processing step (S400), an equipment alarm is generated based on the result of the memory leak determination in the memory leak determining step (S300).

That is, the user may be notified with the equipment alarm together with information including a name of the application in which the memory leak occurred and a memory usage of an application in which the memory leak occurred.

If an alarm occurs in the alarm processing step (S500), the process may proceed to the memory usage collecting step (S100). The reason is that the memory leak determination is a preventive purpose for the memory usage exceeding an allowable value so that the driving of the substrate processing apparatus is not stopped. In addition, since it is necessary to determine whether there is a memory leak by collecting the memory usage even after the alarm occurs, it is necessary to proceed to the memory usage collecting step (S100).

If the alarm occurs in the alarm processing step (S500), the process does not proceed to the memory usage collecting step (S100) and the process of monitoring the memory usage may be terminated by the user or may be terminated by the initial setting.

On the other hand, in the alarm processing step (S500), parameters including the threshold value, the predetermined periods L1 and L2, the threshold number of updating times N, and the like used for determining the memory usage leak may be updated based on measures for substrate processing equipment.

The method of monitoring the memory usage according to the embodiment of the present invention includes collecting the memory usage for at least one of the entire application, each application, and the specific application, storing the collected memory usage, determining whether there is the memory leak based on the stored memory usage, and processing the alarm based on the memory leak determining result.

A substrate processing apparatus will be described below.

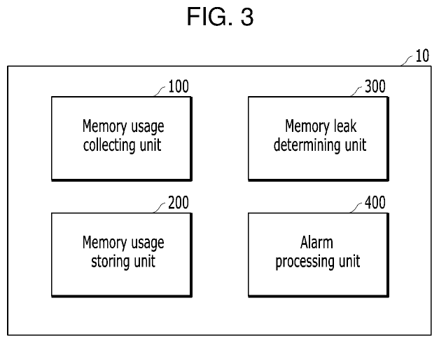

FIG. 3 is a diagram illustrating a substrate processing apparatus according to an embodiment of the present invention.

A substrate processing apparatus 10 using the method of monitoring the memory usage includes a memory usage collecting unit 100, a memory usage storage unit 200, a memory leak determining unit 300, and an alarm processing unit 400.

The memory usage collecting unit 100 performs the memory usage collecting step (S100) for collecting the memory usage of the substrate processing apparatus 10 according to a predetermined collection period.

The memory usage storing unit 200 performs the memory usage storing step (S200) for accumulating and storing the memory usage.

The memory leak determining unit 300 performs the memory leak determining step (S300) for determining a memory leak based on the memory usage. That is, the memory leak determining unit 300 determines whether there is a memory leak by comparing the memory usage with a predetermined threshold value, and when the memory usage does not exceed the predetermined threshold value, whether there is a memory leak is determined based on a change trend of the memory usage.

The alarm processing unit 400 performs the alarm processing step (S400) for generating an equipment alarm based on the determination result of the memory leak.

Meanwhile, the process of monitoring the memory usage may be performed in a main computer provided in the substrate processing apparatus or a separate computer.

The detailed contents of each configuration are the same as those described above in the method of monitoring the memory usage, and the description thereof will be omitted.

According to the present invention, productivity of the substrate processing apparatus can be increased by preventing the driving stop of the substrate processing apparatus in advance by judging the memory leak.

According to the present invention, when it is determined that there is a memory leak, the user may recognize in advance the existence of the memory leak through an alarm.

According to the present invention, since it is not necessary for the user to directly monitor the memory leak, manpower, time, and cost may be saved in monitoring the memory usage.

According to the present invention, it is possible to determine which one of the applications has used the memory beyond the allowable value by determining the memory leak with respect to the memory usage for the entire application and the memory usage for each application.

Although the embodiments of the present invention have been described in detail with reference to the accompanying drawings, the present invention is not limited thereto and may be embodied in many different forms without departing from the technical concept of the present invention. Therefore, the embodiments of the present invention are provided for illustrative purposes only but not intended to limit the technical concept of the present invention. The scope of the technical concept of the present invention is not limited thereto. Therefore, it should be appreciated that the aforementioned embodiments are illustrative in all aspects and are not restricted. The protective scope of the present invention should be construed based on the following claims, and all the technical concepts in the equivalent scope thereof should be construed as falling within the scope of the present invention.

[Explanation of Numeral References and Symbols]

10: Substrate processing apparatus
100: Memory usage collecting unit
200: Memory usage storing unit
300: Memory leak determining unit
400: Alarm processing unit

1. A method of monitoring a memory usage comprising:
a memory usage collecting step of collecting a memory usage according to a predetermined collection period;
a memory leak determining step of determining a memory leak based on the collected memory usage; and
an alarm processing step of generating an equipment alarm based on the determining result of the memory leak,
wherein the memory leak determining step includes a first memory leak determining step of determining the memory leak by comparing the memory usage with a predetermined threshold value and a second memory leak memory step of determining the memory leak based on a change trend of the memory usage when the memory usage does not exceed the predetermined threshold value.

2. The method of monitoring a memory usage of claim 1, wherein in the first memory leak determining step, if the memory usage exceeds the predetermined threshold value, it is determined that there is the memory leak.

3. The method of monitoring a memory usage of claim 2, wherein the memory usage is at least one of a memory usage for the entire application and a memory usage for each application.

4. The method of monitoring a memory usage of claim 1, further comprising:
a storing step of storing the collected memory usage in a memory,
wherein the second memory leak determining step includes determining the number of times of updating the maximum value of the memory usage during a predetermined period in the memory usage stored for each collection period and determining a memory leak when the number of times of updating the maximum value of the memory usage exceeds the threshold number of updating times during the predetermined period.

5. The method of monitoring a memory usage of claim 1, further comprising:
a storing step of storing the memory usage collected for each collection period in a memory,
wherein the second memory leak determining step includes determining whether or not to update the maximum value of the memory usage during a predetermined period in the memory usage stored for each collection period and determining a memory leak when the updating of the maximum value of the memory usage continuously occurs during the predetermined period.

6. The method of monitoring a memory usage of claims 4, wherein the memory usage is at least one of a memory usage for the entire application and a memory usage for each application.

7. The method of monitoring a memory usage of claims 5, wherein the memory usage is at least one of a memory usage for the entire application and a memory usage for each application.

8. A substrate processing apparatus comprising:
a memory usage collecting unit configured to collect a memory usage according to a predetermined collection period;
a memory leak determining unit configured to determine a memory leak based on the memory usage; and
an equipment alarm processing unit configured to generate an equipment alarm based on the determining result of the memory leak,
wherein the memory leak determining unit determines the memory leak by comparing the memory usage with a predetermined threshold value and determines the memory leak based on a change trend of the memory usage when the memory usage does not exceed the predetermined threshold value.

9. The substrate processing apparatus of claim 8, wherein the memory leak determining unit determines the memory leak if the memory usage exceeds the predetermined threshold value when determining the memory leak by comparing the memory usage with the predetermined threshold value.

10. The substrate processing apparatus of claim 9, wherein the memory usage is at least one of a memory usage for the entire application and a memory usage for each application.

11. The substrate processing apparatus of claim 8, further comprising:
a memory usage storing unit of accumulating and storing the memory usage,
wherein the memory leak determining unit determines the number of times of updating the maximum value of the memory usage during a predetermined period in the memory usage accumulated and stored for each collection period when determining the memory leak based on a change trend of the memory usage and determines a memory leak when the number of times of updating the maximum value of the memory usage exceeds the threshold number of updating times during the predetermined period.

12. The substrate processing apparatus of claim 8, further comprising:
a memory usage storing unit of accumulating and storing the memory usage,
wherein the memory leak determining unit determines whether or not to update the maximum value of the memory usage during a predetermined period in the memory usage accumulated and stored for each collection period and determines a memory leak when the updating of the maximum value of the memory usage continuously occurs during the predetermined period.

13. The substrate processing apparatus of claim 11, wherein the memory usage is at least one of a memory usage for the entire application and a memory usage for each application.

14. The substrate processing apparatus of claim 12, wherein the memory usage is at least one of a memory usage for the entire application and a memory usage for each application.
